(19) United States
(12) Patent Application Publication
(10) Pub. No.: US 2020/0016842 A1
(43) Pub. Date: Jan. 16, 2020

(54) METHOD FOR CREATING A CONNECTION BETWEEN COMPONENTS CONSISTING OF DIFFERENT PLASTIC MATERIALS AND ASSOCIATED CONTAINER WITH POURING ATTACHMENT

(71) Applicant: ALPLA Werke Alwin Lehner GmbH & Co. KG, Hard (AT)

(72) Inventors: Florian MÜLLER, Salzburg (AT); Benjamin HAAS, Lauterach (AT)

(73) Assignee: ALPLA Werke Alwin Lehner GmbH & Co. KG, Hard (AT)

(21) Appl. No.: 16/563,184

(22) PCT Filed: Feb. 20, 2018
(86) PCT No.: PCT/EP2018/054146

§ 371 Date: Sep. 9, 2019

(30) Foreign Application Priority Data
Mar. 9, 2017 (CH) 00286/17

(51) Int. Cl. B29C 65/16

(52) U.S. Cl. CPC B29C 65/1616; B29C 65/1635; B29L 2031/712; B29C 65/1674; B29C 65/1677; B29C 65/1654

(57) ABSTRACT

A method for creating a connection between components of different plastics. A first section can consist of a first plastic whose main constituent is polarised plastic, and a second section can consist of a second plastic whose main constituent is non-polar plastic. The method includes creating the connection between the first section and the second section with help of beamed-in laser energy; subjecting the first section to incident laser energy, the first section being at least partly transparent with regard to the incident laser energy; and absorbing beamed-in laser energy at least partly in a joining region, in which the first and the second sections bear on one another in an overlapping manner amid action of force, to create a positive, unreleasable connection between the two components.

### RELATED APPLICATIONS

This application claims priority as a continuation application under 35 U.S.C. § 120 to PCT/EP2018/054146, which was filed as an International Application on Feb. 20, 2018 designating the U.S., and which claims priority to Swiss Application 00286/17 filed in Switzerland on Mar. 9, 2017. The entire contents of these applications are hereby incorporated by reference in their entireties.

### FIELD

A method is disclosed for creating a connection between components of plastic materials, the plastic materials being relative to one another. A container manufactured according to the method has a pour-out attachment.

### BACKGROUND INFORMATION

Different techniques are known for connecting components of plastic materials, the plastic materials being different relative to one another, are known from the state of the art. Different types of positive connections, friction-fit connections, connection by way of deformation, such as e.g. rivets, connections by way of mechanical aids, such as e.g. screws, and material-fit connections, for example welding connections or bonding connections, are counted amongst these. Laminations for the connection of different plastic materials to one another are also known.

Notwithstanding the mechanical strengths which such plastic-plastic connections must have, there is often demand that the connections of components of plastic materials different from one another should be sealed for example with respect to fluids, thus gases and liquids, and pourable goods such as powder for example. This task is not trivial when considering the different physical and chemical characteristics which the components containing (e.g., consisting of) plastics which are different from one another can have. The connection of a pour-out to a container neck is given as an example. The container and its neck can for example consist of polyethylene terephthalate (PET), whereas the pour-out can for example consist of polypropylene (PP). PET therefore belongs to the polar plastics and PP to the non-polar plastics. It is known that a material-fit connection of these two plastics, generally of polar and non-polar plastics, cannot be done amongst one another. In contrast to this, the welding of polar plastics amongst one another and of non-polar plastics amongst one another can be done.

The receptacles which in the past have for example been of tin sheet or non-ferrous sheet, of glass or also of ceramic are being increasingly replaced by receptacles of plastic. In the meanwhile, it is predominantly plastic receptacles which are used in particular for the packaging of fluid substances, for example of drinks, flowable foodstuffs such as e.g. ketchup, sugo, pesto, sauces, mustard, mayonnaise and the like, household products, care products, cosmetics, etc. With this substitution, it is most definitely the low weight and the lower costs which play an important role. The use of recyclable plastic materials, the use of bio-plastics and the overall more favourable total energy balance on their manufacture also contribute to the acceptance of plastic receptacles, in particle of plastic bottles, by the consumer.

Essentially two methods have become established for an inexpensive manufacture of a large part of the plastic containers used today, specifically the extrusion blow moulding method and the stretch blow moulding method. With the extrusion blow moulding method, a section of a plastic tube, the plastic tube being extruded in a single-layered or multi-layered manner, is inserted into a mould cavity of a blow moulding tool and is inflated into the desired container by way of a medium, usually air, which is fed at overpressure. With an injection moulding method, a preform of a usually elongate, tube-like design which at its one longitudinal end is closed with a base and at its other longitudinal end includes a neck section is firstly manufactured in an injection moulding method. The manufacture of the preform can be effected temporally and/or spatially separately from the subsequent blow moulding method. In an alternative method, the manufactured preform is processed further, directly after its manufacture without an intermediate cooling. With so-called injection blow moulding, this can be effected with the help of a single machine facility, on which the preform is injection moulded, inflated into a container of the desired shape and removed from the mould. Concerning the blow moulding method, the preform can also yet additionally be axially stretched by way of a stretching mandrel.

Materials whose main constituent, for example 90% and more, consists of PET, PET-G, HDPE, PP, PS, PVC, PEN, PA, copolymers of the cited plastics, bioplastics such as for example PLA, PEF or PPF, filled plastics and/or mixtures of the mentioned plastics are applied as raw materials for the manufacture of the preform for the stretch blow moulding method. The plastics or parts thereof can be coloured and/or coated. A condition for the useable plastics is their suitability for the respective manufacturing method of the preform. Hereby, the preform can already be used as a finished container. The container can also be manufactured from the preform by way of a subsequent stretch blow moulding method or also by way of extrusion blow moulding. The used plastics can be different due to the different manufacturing method.

Depending on the type of substance to be poured out, the plastic containers are often provided with different pour-outs. For example, the pour-out should permit a spill-free pouring-out, simplify a metering or permit the substance which is contained in the container to be brought out in an extensive manner. Apart from the adaptation to the respective substance, the use of a pour-out also can have an advantage that the same type of plastic containers can be provided with a different pour-out depending on the wish of the bottler. The pour-out can be provided with devices which permit a closure of the container. For this, for example a pivotable cover part can be articulated on the upper side of the pour-out. Alternatively to this, means which permit a positive connection, for example with a rotatory closure, can be provided on the container neck or on the pour-out. The means can e.g. be outer thread sections or guide mechanisms for a bayonet closure and the like, which interact with correspondingly designed and configured positive-fit elements on the closure part. The pour-out can, for example, consist of a plastic material which is different to the plastic material of the plastic container, such as e.g. polyolefin, in particular PP, and is mostly manufactured in an injection moulding method.

### SUMMARY

A method for creating a connection between components of plastics is disclosed, the plastics being different relative to one another, in which a first section of a first component and a second section of a second component, the second component being different from the first component, are fixedly connected to one another, wherein the first section consists of a first plastic whose main constituent is polarised plastic, and the second section consists of a second plastic whose main constituent is non-polar plastic, or vice versa, the method comprising: creating a connection between the first section and the second section with the help of beamed-in laser energy; subjecting the first section to incident laser energy, the first section being at least partly transparent with regard to the incident laser energy; and absorbing beamed-in laser energy at least partly in a joining region, in which the first and the second sections bear on one another in an overlapping manner amid action of force, to create a positive, unreleasable connection between the two components.

A plastic receptacle is also disclosed, comprising: a body which encloses a filling volume; a neck section which connects thereto; and a first section of a first plastic whose main constituent is polar plastic and is connected to a pour-out attachment, and a second section of a second plastic whose main constituent is non-polar plastic, or vice versa; wherein the first and the second sections overlap to form a positive, unreleasable connection in a joining region between the first section and the second section.

### BRIEF DESCRIPTION OF THE DRAWINGS

Further advantages and features of the invention are to be derived from the subsequent description of embodiment variants with reference to the schematic drawings. In a representation which is not true to scale:

FIG. 1 shows an axially sectioned representation of an exemplary plastic container with pour-out attachment;

FIG. 2 and FIG. 3 show two exemplary representations for explaining the connection principle;

FIG. 4 shows an axial exemplary representation of a second embodiment of a plastic container with a pour-out attachment; and

FIG. 5 shows an enlarged detail of the exemplary plastic container with the pour-out attachment according to FIG. 4.

### DETAILED DESCRIPTION

A method and a receptacle with a pour-out element are disclosed, of which components of plastic materials, the plastic materials being different relative to one another, can be connected to one another. The method can be applied for example as a fluid-tight connection of a pour-out element to a blow-moulded plastic container and as a fluid-tight connection of the pour-out to a preform which is manufactured in an injection moulding method. Exemplary embodiments can forgo adhesives and/or additional mechanical connection elements. A corresponding receptacle with a pour-out element which is connected thereto is also disclosed, wherein the receptacle and the pour-out element include (e.g., consist of) plastics which are different relative to one another.

A method is disclosed for creating a connection between components of plastic materials, the plastic materials being different from one another, as well as a plastic receptacle, with attendant features.

In an exemplary method for creating a connection between components of plastics, the plastics being different relative to one another, a first section of a first component and a second section of a second component, the second component being different relative to the first component, are fixedly connected. Herein, the first section includes (e.g., consists of) a first plastic, whose main constituent is polar plastic and the second section includes (e.g., consists of) a second plastic whose main constituent is non-polar plastic, or vice versa. The connection between the first section and the second section of the first and the second components respectively is created with the help of beamed-in laser energy. The first section which is subjected to beamed-in laser energy first of all is at least partly transparent with regard to the beamed-in laser energy. The beamed-in laser energy is absorbed at least partly in a joining region, in which the first and the second sections bear on one another in an overlapping manner amid the action of force. In this manner, a positive, unreleasable connection is created between the two components or between the first section and the second section.

In contrast to known laser welding methods, components whose sections which are to be connected are formed of a polar and of a non-polar plastic can be used as joining partners for the disclosed method. By way of this, on being subjected to and with the absorption of the beamed-in laser energy, no common melt core of the two components or joining partners forms. In contrast, the subjected first of the two joining partners is heated locally and softens, to such an extent that the second plastic of the second joining partner, due to the force acting on it, as rule produced by prestressing, extends into this first plastic amid a material displacement of the first plastic of the first joining partner. On account of this, a positive-fit which can be additionally assisted by a non-positive fit is produced between the two joining partners. The material displacement and herewith the connection of the two joining parts can be essentially linear and/or extensive.

It is to be understood that the first section and the second section which as a rule are both designed and configured in an extensive manner, overlap one another for producing the connection. The connection which is produced between the first section and the second section can be unreleasable at least in the axial direction, thus under the action of shear forces. Hereby, the second joining partner or the second section of the joining partner can include (e.g., consist of) a plastic which at least partly absorbs the beamed-in laser energy. On account of this, the partial absorption can be effected beyond the joining region, even also in the plastic of the second joining partner or its second section. The at least partial absorption of the incident laser energy is not therefore limited to the joining region.

An additive can be arranged in the joining region, the additive assisting the energy input into the two joining partners by way of at least partial absorption of the beamed-in laser energy, so that the at least partial absorption of the beamed-in laser energy can be effected in a manner limited to the joining region. Hereby, as a rule both joining partners can be at least partly transparent to the incident laser energy. The additive or the plastic can include fillers which at least partly absorb the wavelength of the beamed-in laser light. The additive can be deposited onto one of the joining partners or also onto both joining partners, for example in the joining region, or be mixed into the plastic at least in the joining region. The plastic as such can also be already at least partly absorbing with regard to the incident laser energy, so that one can make do without a mixing-in of fillers and/or the additive.

Furthermore, a plastic which at least partly absorbs the beamed-in laser energy can be additionally combined with an additive in the joining region. Given a suitable selection of the additive, the absorption can be assisted by way of the partial reflection at the fillers. Given a suitable design and configuration of the components and/or of the joining region, the connection can also be fluid-tight, thus sealed with respect to liquids and gases, but also sealed with respect to pourable solid matter such as powder for example. The laser energy can be introduced in a direct manner to where it is required for softening the one plastic, due to the arrangement of the additive in the joining region between the first and the second section. It is to be understood that the other plastic is also heated, at least by way of the thermal radiation.

Basically, if necessary or desired, the pointwise introduction of the laser energy is also possible herewith. Accordingly, a large-surfaced heating of the components which could damage these is no longer necessary. For example, the pour-out attachment can be manufactured from PP and the neck section 3 of PET. The softening of PET begins from for example about 70° C. and that of PP from for example about 120° C. The PET is therefore already softened at a temperature, at which the PP is still solid. Herewith, on account of its prestressing, the PP can extend into the PET amid its displacement. The PP can likewise soften due to further heating and in the boundary layer with the PET forms a mixture which in the cooled state leads to an unreleasable connection. The method as disclosed can, for creating a connection between two components of plastics materials, the plastic materials being different from one another, be carried out in a simple, rapid and inexpensive manner. An exemplary method basically can involve practically no different construction in apparatus when compared to known laser welding methods.

According to an exemplary embodiment, the second section can include a plastic which at least partly absorbs the incident laser energy. For example, the remaining body of the second component can be designed and configured from a plastic which is transparent to the beamed-in laser energy, such that only the second section which includes (e.g., consists of) a plastic which at least partly absorbs the beamed-in laser energy. This plastic can be deposited for example in a 2K injection moulding method. As a rule, both plastics, thus the plastic of the remaining body of the second component and the plastic of the second section, can either be polar or non-polar. The plastic of the second section can differ from the plastic of the remaining body of the second component by way of fillers and/or an additive which at least partly absorb the laser energy being admixed to the plastic, from which the remaining body of the second component is manufactured.

According to an exemplary embodiment, the second component can include a plastic which at least partly absorbs the incident laser energy. Accordingly, the first component will then be at least partly transparent to the beamed-in laser energy, so that the first component is beamed-through, hits the second part and there leads to softening of the first and the second section on account of the absorption.

According to an exemplary embodiment, an additive which is at least partly absorbing to the incident laser energy is arranged in the joining region.

An exemplary method variant can involve the additive being arranged at least in that section which is reached by the incident laser energy after beaming through the first section. Herewith, the first section is transparent to the wavelength of the applied laser light, the light being at least partly absorbed on the second section. The energy absorption via the additive on the one hand and the thermal radiation on the other hand is sufficient to produce the positive fit, assisted by a non-positive fit, between the joining partners.

In an exemplary method variant, the additive is provided on or in the second section of the second component which is not subjected to the laser energy until after beaming through the first section.

In an exemplary method variant, the additive is hereby deposited as a coating. Hereby, the additive can also be deposited as a second plastic component by way of over-injecting on manufacturing the component. The coating can also be effected by way of ink jet printing, tampon printing, flexo-printing or the like. Materials which include (e.g., consist of) soot, contain soot and/or contain substances which at least partly absorb the laser energy are used as a coating. Hereby, a multi-purpose lamination can also be applied instead of soot.

In an exemplary method variant, the additive is embedded at least into the plastic of the joining region of the first and/or the second section. The components which are designed and configured in such a manner can be manufactured for example in a special 2-component plastic injection moulding method. In exemplary embodiments, the laser-energy-absorbing additive can be distributed, for example embedded, essentially uniformly at least over the second section of the second component.

An exemplary method according to the disclosure can be applied for a connection of differently designed and configured plastic components. The components can be designed and configured in a flat or arcuate manner. An exemplary method according to the disclosure however has been found to be particularly useful on connecting function parts, such as e.g. a pour-out element, to a receptacle. With this method variant, the pour-out attachment can be applied as a first or second component and a plastic receptacle which encloses a filling volume as a corresponding second or first component. A residue-free connection of such components is indeed of particular interest in the foodstuff industry. The plastic receptacle can herein be designed and configured as a preform which can be manufactured for example in an injection moulding method or in a compression moulding method, or as a plastic container which is manufactured in a blow moulding method.

According to an exemplary embodiment, the pour-out attachment and the plastic receptacle have a prestressing in the joining region before introducing the laser energy. This prestressing as a rule acts roughly perpendicularly onto the later loading direction of the two components which are joined onto one another. The prestressing is for example between about 5 MPa and about 35 MPa, preferably for example between about 15 MPa and about 30 MPa and particularly preferably between for example about 20 MPa and about 27 MPa.

An exemplary method variant can include a sealing skirt being shaped out on the pour-out attachment, the sealing skirt being designed in a cylindrical, conical or convex manner. Furthermore, the joining region can be formed by the sealing skirt and a receiving section of the plastic receptacle, the receiving section corresponding to the sealing skirt and the plastic receptacle enclosing a filling volume. The sealing skirt, with a wall of a neck section of the plastic receptacle can form a sealing zone. The fluid-tight connection between the pour-out attachment and the plastic receptacle, formed by the entry of laser energy, can herein be effected for example directly in the sealing zone. In an exemplary method variant, the sealing function can be separated from the positive connection between the pour-out attachment and the plastic receptacle. In this case, the joining region can be formed by a first section and a second section which are not the sealing skirt and a receiving section of the plastic receptacle, the receiving section corresponding to the sealing skirt and said plastic receptacle enclosing the filling volume. For example, this section can be designed and configured as a cylindrical jacket which surrounds the sealing skirt and which engages around a neck part of the plastic receptacle, whereas the sealing skirt projects into a receiving section on the neck part of the plastic receptacle and together with an inner wall of the neck part forms a sealing zone. Instead of a jacket, wall parts which project axially away and which can be designed and configured for a connection to the outer wall of the plastic receptacle, can also be formed on the pour-out attachment.

The sealing skirt can be designed and configured in a manner such that it has a prestressing with respect to a receiving section of the plastic receptacle. This can improve the sealing function and/or simplify the creation of a positive connection. The prestressing can herein be achieved by way of an overdimensioning of the pour-out attachment in its sealing skirt with respect to a diameter of the receiving section of the plastic receptacle.

One of the two components which are to be connected to one another, for example a component which is designed and configured as a plastic receptacle, can be manufactured of a plastic whose main constituent, for example 70% or more, is polar plastic, selected from the group consisting of PET, PET-G, PET-X, PVC, PEN, PA, PC, PU, PMMA, POM, copolymers of the cited plastics, bioplastics such as for example PEF or PPF, filled plastics and/or mixtures of the mentioned plastics. The mentioned plastics have been known for some time in view of their physical and chemical characteristics and in particular are also well suited for the application in a stretch blow moulding method. The other of the two components which are to be connected to one another, for example a component which is designed and configured as a pour-out attachment, can be manufactured of a plastic whose main constituent, for example 70% or more, is non-polar plastic, selected from the group consisting of HDPE, PP, PS, LDPE, LLDPE, PTFE, PS, copolymers of the cited plastics, bioplastics such as for example PLA, filled plastics and/or mixtures of the mentioned plastics. These plastics have also been known for some time in view of their physical and chemical characteristics and for example are also well suited for the application in an injection moulding method.

As a source for the beamed-in laser energy, a laser with a wavelength of for example, 800 nm to 1200 nm or for example, of 1800 nm to 2400 nm is used for creating of the positive connection, possibly assisted by a non-positive fit, between the two plastic components which are manufactured from polar and non-polar plastic. Lasers of these wavelengths provide the desired energy which is necessary or desired for the creation of the positive connection. The laser is for example a diode laser. Diode lasers have low procurement and maintenance costs, have a long service life and are high-powered.

Concerning an exemplary embodiment variant for connecting rotationally symmetrical components, the laser energy can be simultaneously beamed in over 360°. This can be achieved for example with the help of special laser optics. If required or desired, the incident laser energy can be selectively concentrated onto selected angular regions within 360° with the help of shielding screens. Furthermore, for connecting rotationally symmetrical components, these can be rotatorily and/or translatorily moved past a laser for beaming in the laser energy. Hereby, as a rule, the laser energy is introduced in a pointwise manner. Generally, a uniform connection quality over the periphery is achieved by way of the selection of the speed. The first section and the second section can for example be parallel and the laser light is introduced perpendicularly to the two sections.

An exemplary method according to the disclosure is suitable for the manufacture of a plastic receptacle with a body which encloses the filling volume and with a neck section which connects thereto and which is connected to a pour-out attachment. Herein, the pour-out attachment in its joining region can be positively connected to the joining region of the neck section.

According to an exemplary embodiment of the disclosure, a plastic receptacle with a body which encloses a filling volume and with a neck section which connects thereto and which is with a first section of a first plastic whose main constituent is polar plastic and which is connected to a pour-out attachment with a second section of a second plastic whose main constituent is non-polar plastic, or vice versa, is disclosed. The first section and the second section can overlap, and a positive, unreleasable connection is formed in a joining region between the first section and the second section. By way of this, a plastic container can be manufactured of polar plastic, onto which a pour-out attachment can be connected in a fluid-tight and unreleasable manner.

According to an exemplary embodiment of the disclosure, in the joining region, the first plastic is displaced by the second plastic amid the formation of an essentially concave boundary layer. The first plastic which is softened by the introduced laser energy, in combination with the second plastic which is under prestressing can be displaced at the warmer and thus softer regions to a greater extent that at the colder and thus less soft regions. Herewith, an essentially concavely arched boundary layer can form in the first plastic.

According to an exemplary embodiment of the disclosure, in the boundary layer, the first plastic and the second plastic have flowed into one another essentially without the formation of a melt connection. Hereby, the polar and the non-polar plastic can be unreleasably meshed with one another in the boundary layer.

According to an exemplary embodiment of the disclosure, the first section which is formed on the inner side of the neck section and the second section which is formed on the outer side of the pour-out attachment can be unreleasably positively connected to one another in a fluid-tight manner in the joining region.

According to an exemplary embodiment of the disclosure, the pour-out attachment includes a cylindrical, conical or convexly designed sealing skirt which with a receiving section of the neck section which corresponds to the sealing skirt forms a fluid-tight connection, wherein the joining region of the pour-out attachment and of the neck section of the plastic receptacle is different to the fluid-tight connection. Hereby, the joining region and the sealing zone are different to one another. This permits an optimised design and configuration of the respective sealing and joining regions. Hereby, the additive can be deposited or introduced at an inner side of the pour-out attachment which forms the joining region.

According to an exemplary embodiment of the disclosure, the joining region of the pour-out attachment is formed by at least one continuation which extends axially, engages over the neck section at its outer side and is unreleasably connected to the outer side. It is not necessary for the connection to extend over the whole periphery. In contrast, the pour-out attachment can also be positively connected to the plastic receptacle at only two or more locations.

The plastic receptacle can be a preform which can be manufactured for example in an injection moulding method or in a compression moulding method, or a blow-moulded plastic container. For example, it can be a plastic container which is stretch blow moulded from a preform.

The pour-out attachment which is manufactured from a non-polar plastic and which contains (e.g., consists of) a plastic which is different to the plastic material of the receptacle can include an integrally formed closure part.

It is clear to the person skilled in the art that features which are directed to the method, inasmuch as make sense, can also be conferred upon the device and vice versa.

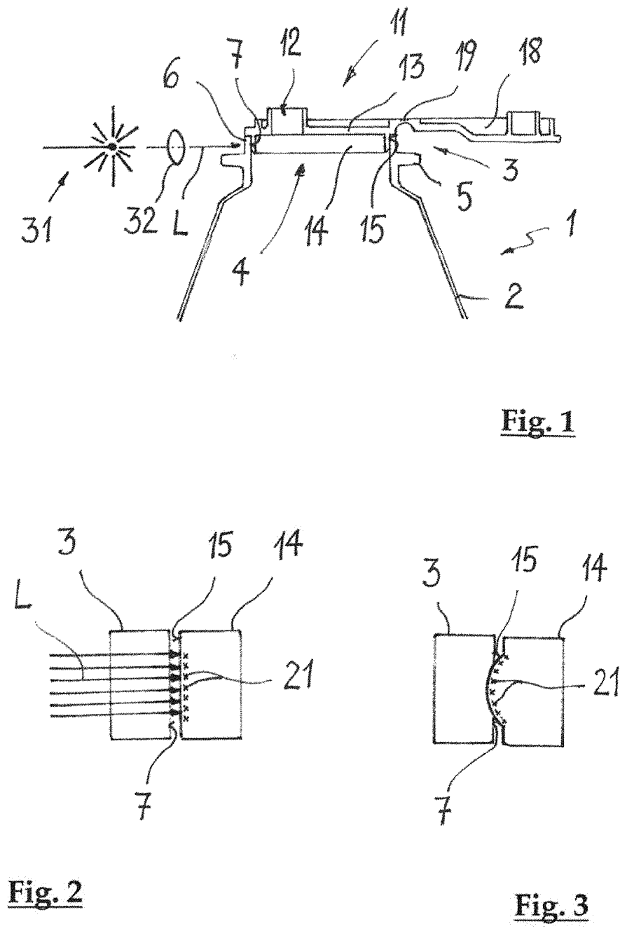

A method for creating a connection between two components which consist of plastics which are different from one another, of which the first component is of a first plastic whose main constituent is polar plastic, and the second component which is different relative to the first component is of a second plastic whose main constituent is of non-polar plastic, or vice versa, is explained hereinafter with the example of a plastic container which is provided with a pour-out attachment. A plastic container which is manufactured for example in a stretch blow moulding method from perform which has been previously manufactured in an injection moulding method or in a compression moulding method is provided with the reference numeral 1 in FIG. 1. The plastic container 1 includes a container body 2 which is indicated by the reference numeral 2 and onto which a neck section 2 which has a rotationally symmetrical an opening 4 connects. The container body 2 and the neck section 3 can be separated from one another by way of a so-called support ring 5. The neck section 3 including the support ring 5 as a rule remains unchanged on stretch blow moulding. The neck section 3 and the support ring 5 therefore correspond to the neck section and the support ring of the preform which is previously manufactured in an injection moulding method or extrusion method. A method according to the disclosure can therefore be implemented just as well on a preform as on a container which is manufactured therefrom.

FIG. 1 shows a pour-out attachment which is assembled on the opening 4 and which has the reference numeral 11. For reasons of a better overview, a different hatching of the plastic container 1 and of the pour-out attachment 11, shown in the axial section, has been done away with. The pour-out attachment 11 includes a plate-like flange part 13 which is provided with a pour-out opening 12 and which is supported on a mouth edge 6 which edges the opening 4 of the neck section 3. The pour-out opening 12 of the pour-out attachment 11 is reclosable and for this reason is provided with a closure part 18 which is designed for example as a flap closure (flip top) and is articulated on the plate-like flange part 13 via a hinge joint 19. A sealing skirt 14 extends from the plate-like flange part 13 into the neck section 3. The sealing skirt 14 can be designed in a cylindrical, conical or convex manner and ensures a fluid-tight connection to an inner wall 7 of the neck section 3 in the receiving region for the sealing skirt 14. The sealing skirt 14, with respect to the inner diameter in the neck section 3, can have an overdimension so that its outer wall 15 has a prestressing with respect to the inner wall 7 of the neck section 3. Given an inner diameter of 26 mm to 30 mm and also larger, this overdimension measured over a largest outer diameter of the sealing skirt 14 can be for example 0.2 mm to about 1 mm. With smaller inner diameters of the neck section in the receiving region, the overdimension can also be smaller and for example be 0.1 mm to 0.3 mm. The outer wall 15 of the sealing skirt 14 and the inner wall 7 of the neck section 3 in the receiving region for the sealing skirt 14 form a sealing zone between the pour-out attachment 11 and the neck section 3 of the plastic container 1, said sealing zone being fluid-tight, thus being sealed with respect to gases and liquids, but also with respect to solid substances such as powder.

The plastic container 1 includes (e.g., consists of) for example a first plastic whose main constituent, for example 70% or more, is polar plastic, selected from the group consisting of PET, PET-G, PET-X, PVC, PEN, PA, PC, PU, PMMA, POM, copolymers of the cited plastics, bioplastics such as for example PEF or PPF, filled plastics and/or mixtures of the mentioned plastics. In the present exemplary embodiment, the pour-out attachment 11 includes (e.g., consists of) the second plastic whose main constituent, for example, 70% or more, is non-polar plastic, selected from the group consisting of HDPE, PP, PS, LDPE, LLDPE, PTFE, PS, copolymers of the specified plastics, bioplastics such as for example PLA, filled plastics and/or mixtures of the mentioned plastics.

The laser welding method which is known is suitable for creating a mechanically loadable connection between the neck part 3 of the plastic container 1 and the pour-out attachment 11, the connection being free of residues, for example micro-particles, adhesive residues and the like and being able to be created in a rapid manner and simply integrated into the process. However, only plastics of the same polarity are weldable to one another, thus polar plastics to polar plastics and non-polar plastics to non-polar plastics. Plastic of a different polarity cannot be welded to one another, thus polar plastics to non-polar plastics or vice versa. The first plastic of the plastic container 1 which is polar, and the second plastic of the pour-out attachment 11 which is non-polar, are not therefore weldable to one another. It has been surprising found that components which consist of plastics which are different from one another, thus of polar and non-polar plastics, are connectable to one another by way of subjection to laser energy. The connection is adequately mechanically loadable and for example permits a fluid-tight, in particular liquid-tight connection of a pour-out attachment to a plastic receptacle, which for example can be an injection moulded or extruded preform or a plastic container which is blow moulded from a preform or also a tube, thus a stretch blow moulded or an extrusion blow moulded plastic container.

A laser is indicated with the reference numeral 31 in FIG. 1. The laser 1 has a wavelength for example of 800 to 1200 nm. It is the case for example of a diode laser. The laser energy L which is beamed in by the laser 31 can be simultaneously directed onto the joining regions of the neck section 3 and of the sealing skirt 14 of the pour-out attachment 11 over 360° with the help of special optics 32. The laser light in is directed perpendicularly onto the neck part 3 and herewith also perpendicularly to the outer wall 15 of the sealing skirt 14 of the pour-out attachment 11 in an ideal manner. If necessary or desired, the beamed-in laser energy can be selectively concentrated onto selected angular regions with the help of apertures. The neck part 3 with the inserted pour-out attachment 1 can also be rotarorily and/or translatorily moved past the laser source at a speed which is favourable for the method.

FIGS. 2 and 3 schematically show the conditions on creating a connection between two components, of which the first component, specifically the neck part 3 includes (e.g., consists of) a first polar plastic, and the second component, specifically the sealing skirt 14 includes (e.g., consists of) the second non-polar plastic. For reasons of a better overview, the two components are represented at a distance to one another. However, it is expressly pointed out that the two components overlap one another and are pressed onto one another, at least in the region which is subjected to laser energy. In the present exemplary embodiment, the inner wall 7 of the neck part 3 and the outer wall 15 of the sealing skirt 14 are under a prestressing of, for example, about (e.g., ±10%) 20 to 27 MPa in the joining region. Ideally, the joining region which is under the prestressing is simultaneously also the sealing zone of the first and the second component.

The region of the prestressing does not have to be subjected to laser energy over the whole periphery for creating an unreleasable and fluid-tight connection between the first and the second component. In contrast, a sectioned beaming-in of laser energy along the line or surface which is prestressed is also sufficient for the unreleasable and fluid-tight connection, wherein the sections can also be designed and configured in a point-wise manner. Hereby, the connection can be designed and configured in a linear or extensive manner.

A first section of a first component, for example the neck section 3 of the plastic bottle 1 is subjected to laser energy L. The neck section 3 is transparent at least partly with respect to the beamed-in laser energy L. After beaming through the neck section 3, the beamed-in laser energy L gets onto the second section of a second component, in the present exemplary embodiment onto the outer wall 15 of the sealing skirt 14 of the pour-out attachment 11.

The laser energy is at least partly absorbed with the help of the additive 21 which is arranged there. Hereby, the second section of the second component, or the outer wall 15 of the sealing skirt 14, the sealing skirt 14 or the second component itself, or the pour-out attachment 11 can be manufactured of a plastic which at least partly absorbs the beamed-in laser energy L. The additive 21 is a substance which absorbs the beamed-in laser energy L and converts it into heat, as well as possible. The additive 21 can consist of soot or include soot and/or substances which at least partly absorb the laser energy. The additive 21 can be deposited as a coating, or be regionally or entirely embedded into the plastic material. As a rule, the additive 21 is arranged on the wall of the second component which faces the first component which is to be beamed through. FIG. 2 accordingly shows the additive 21 in the region of the outer wall 15 of the sealing skirt 14. It is to be understood that the inner wall 7 of the neck section 3 can also be provided with an additive in the insert region, in order to assist in a greater introduction of energy there.

The outer wall 15 of the sealing skirt 14 is heated by way of the incident laser energy L which is absorbed with the help of the additive, and expands on account of the prestressing. The shape of the expansion is bulgy or essentially convex on account of the temperature profile which is caused by the laser radiation. This is represented in FIG. 3.

The inner wall 7 of the neck region 3 is also simultaneously heated and softened by way of the beamed-in laser energy and by radiation heat. The expanding outer wall 15 of the sealing skirt 14 displaces the plastic on the opposite inner wall 7 of the neck region 3 and additionally flows into this. Undefined structures with undercuts which are filled by the plastic of the respective other joining partner form on the outer wall 15 and the inner wall 7, so that the two plastics hook onto one another essentially without forming a weld connection. The pour-out attachment 11 in the present exemplary embodiment is manufactured from PP and the neck section 3 from PET. The softening of PET begins from for example about 70° C. and that of PP from for example about 120° C. The PET is hence already softened at a temperature, at which the PP is still solid. Herewith, the PP on account of its prestressing can extend into the PP amid its displacement. The PP can likewise soften by way of further heating and in the boundary layer with the PET forms a mixture which in the cooled state leads to an unreleasable connection. By way of this, a positive-fit is created between the outer wall 15 of the sealing skirt 14 and the inner wall 7 of the neck region 3.

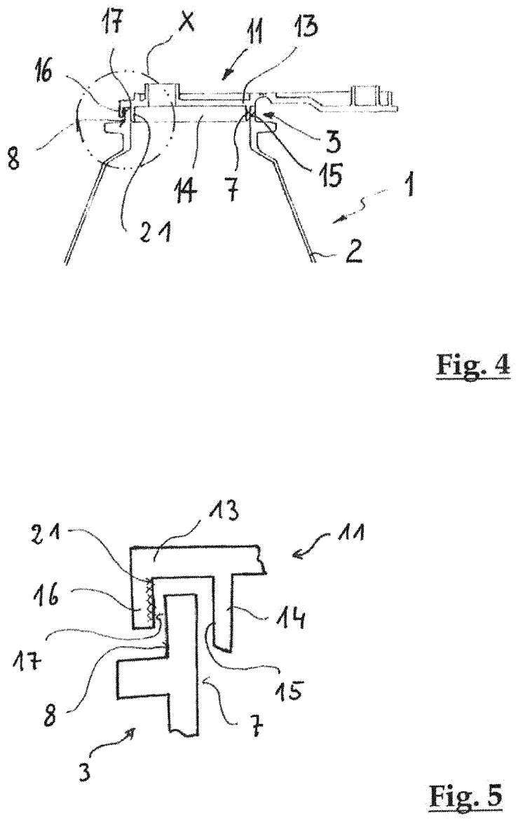

The exemplary embodiment which is represented in FIG. 4 differs from the embodiment example according to FIG. 1 to FIG. 3 in that the joining function and the sealing function between the neck section 3 and the sealing skirt 14 of the pour-out attachment 11 are separated from one another. For this, the pour-out attachment 11 includes for example at least one axial continuation 16 which extends from a peripheral edge of the plate-like flange part 13 along the neck section 3 in the direction of the container body 2. The at least one axial continuation 16 can be designed and configured cylindrically and extend over the complete periphery. Several axial continuations 16 which project from the peripheral edge of the flange part 13, engage over the neck section 3 on its outer wall 8 and bear on the outer wall with prestressing can also be provided.

The axial continuation 16 is subjected to incident laser energy for creating a mechanically loadable connection between the pour-out attachment 11 and the neck section 3 of the plastic container 1 in the radial and axial direction. The at least one axial continuation 16 is at least partly non-absorbing with respect to the incident laser energy. The additive 21 which is arranged on an inner wall 17 of the continuation 16 absorbs the incident laser energy and converts this into heat. The laser energy, at least by way of thermal radiation, also gets to the outer wall 8 of the neck section 3 and softens this. The softening procedure can be additionally assisted by of an additive which is provided on the outer wall 8. The inner wall 17 of the at least one continuation 16 expands as a result of the prestressing. By way of this, it displaces the softened plastic material of the opposite outer wall 8 of the neck section 3 and a positive-fit arises. The joining function between the pour-out attachment 11 and the neck section 3 of the plastic container 1 is shifted onto the outer side of the plastic container 1 by way of this. The sealing zone which is formed by the outer wall 15 of the sealing skirt 4 and the inner wall 7 of the neck section 3 has no connection function on account of this and is free of deformations which are effected by the incident laser energy.

FIG. 5 shows the detail X from FIG. 4. As in FIGS. 2 and 3, the joining partners are also represented distanced to one another for reasons of a better overview. The embodiments concerning FIGS. 2 and 3 are referred to here, specifically the fact that the joining partners abut one another under prestressing in the joining zone which in the present exemplary embodiment is decoupled from the sealing zone. Additionally, the outer wall 15 of the sealing skirt 14 and the inner wall 7 of the neck section 3 are under prestressing for a fluid-tight connection. Clearly visible, the additive 21 is arranged on the inner side 17 of the continuation 16.

The exemplary methods according to the disclosure can be used for a connection of differently designed plastic components. The components can be designed and configured in a flat or arcuate manner. The methods according to the disclosure however in particular has been shown to be useful with the connection of function parts, such as e.g. a pour-out, to a receptacle. Concerning this method variant, a pour-out attachment can be used as a first or second component and a plastic receptacle which encloses a filling volume as a corresponding second or first component. A residue-free connection of such components can be of interest in particular in the foodstuffs industry or in the pharmaceutical industry. The plastic receptacle can herein be designed and configured as a preform which can be manufactured for example in an injection moulding method or in a compression moulding method, or as a plastic container which is manufactured in a blow moulding method. The above description of specific embodiment examples merely serves for the explanation of the invention and is not to be considered as limiting. In contrast, the invention is defined by the patent claims and the equivalents which are derived by the person skilled in the art and are encompassed by the general inventive concept.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method for creating a connection between components of plastics, the plastics being different relative to one another, in which a first section of a first component and a second section of a second component, the second component being different from the first component, are fixedly connected to one another, wherein the first section consists of a first plastic whose main constituent is polarised plastic, and the second section consists of a second plastic whose main constituent is non-polar plastic, or vice versa, the method comprising:
creating a connection between the first section and the second section with help of beamed-in laser energy;
subjecting the first section to incident laser energy, the first section being at least partly transparent with regard to the incident laser energy; and
absorbing beamed-in laser energy at least partly in a joining region, in which the first and the second sections bear on one another in an overlapping manner amid action of force, to create a positive, unreleasable connection between the two components.

2. A method according to claim 1, wherein the second section comprises:
a plastic which at least partly absorbs the incident laser energy.

3. A method according to claim 1, wherein the second component comprises:
a plastic which at least partly absorbs the incident laser energy.

4. A method according to claim 1, comprising:
an additive which at least partly absorbs the incident laser energy being arranged in the joining region.

5. A method according to claim 4, comprising:
arranging the additive at least on that section which is reached by the incident laser energy after beaming through the first section.

6. A method according to claim 5, comprising:
providing the additive on or in the second section.

7. A method according to claim 6, comprising:
depositing the additive as a coating.

8. A method according to claim 7, comprising:
using materials which consist of soot, contain soot and/or contain substances which at least partly absorb the laser energy as a coating.

9. A method according to claim 8, comprising:
embedding the additive at least into the plastic of the joining region of the first and/or the second section.

10. A method according to claim 9, comprising:
distributing the additive essentially uniformly at least over the second section of the second component.

11. A method according to claim 1, comprising:
using a pour-out attachment as a first or second component, and a plastic receptacle which encompasses a filling volume as a corresponding second or first component.

12. A method according to claim 11, comprising:
low moulding the plastic receptacle as a preform or as a plastic container.

13. A method according to claim 12, wherein the pour-out attachment and the plastic receptacle have a prestressing in the joining region before introducing the laser energy.

14. A method according to claim 13, wherein the prestressing is between about 5 MPa and about 35 MPa.

15. A method according to claim 14, comprising:
shaping a sealing skirt on the pour-out attachment in a cylindrical, conical or convex manner.

16. A method according to claim 15, comprising:
forming the joining region by a sealing skirt and a receiving section of the plastic receptacle, the receiving section corresponding to the sealing skirt and the plastic receptacle encompassing a filling volume.

17. A method according to claim 15, comprising:
forming the joining region by a first section and a second section which are not the sealing skirt and a receiving section of the plastic receptacle, the receiving section corresponding to the sealing skirt and the plastic receptacle encompassing a filling volume.

18. A method according to claim 1, wherein the first plastic main constituent is 70% or more polar plastic, selected from the group consisting of PET, PET-G, PET-X, PVC, PEN, PA, PC, PU, PMMA, POM, copolymers of the cited plastics, bioplastics, PEF or PPF, filled plastics and/or mixtures of the mentioned plastics.

19. A method according to claim 1, wherein the second plastic main component is 70% or more non-polar plastic, selected from the group consisting of HDPE, PP, PS, LDPE, LLDPE, PTFE, PS, copolymers of the specified plastics, bioplastics, PLA, filled plastics and/or mixtures of the mentioned plastics.

20. A method according to claim 1, comprising:
applying a laser with a wavelength of 800 nm to 1200 nm or of 1800 nm to 2400 nm as a source for the beamed-in laser energy.

21. A method according to claim 20, comprising:
applying a diode laser as a laser.

22. A method according to claim 1, comprising:
simultaneously beaming laser energy over 360° for connecting rotationally symmetrical components.

23. A method according to claim 22, comprising:
selectively concentrating the beamed-in laser energy onto selected angle regions within 360° with shielding screens.

24. A method according to claim 22, comprising:
connecting rotationally symmetrical components which are rotatorily and/or translatorily moved past a laser for beaming in the laser energy.

25. A plastic receptacle, comprising:
a body which encloses a filling volume;
a neck section which connects thereto; and
a first section of a first plastic whose main constituent is polar plastic and is connected to a pour-out attachment, and a second section of a second plastic whose main constituent is non-polar plastic, or vice versa;
wherein the first and the second sections overlap to form a positive, unreleasable connection in a joining region between the first section and the second section.

26. A plastic receptacle according to claim 25, wherein in the joining region, the first plastic is displaced by the second plastic amid formation of an essentially concave boundary layer.

27. A plastic receptacle according to claim 26, wherein in the boundary layer, the first plastic and the second plastic have flowed into one another essentially without formation of a melt connection.

28. A plastic receptacle according to claim 27, wherein the first section which is formed on an inner side of the neck section and the second section which is formed on the outer side of the pour-out attachment are unreleasably connected to one another in a positive and fluid-tight manner in the joining region.

29. A plastic receptacle according to claim 28, wherein the pour-out attachment comprises:
a cylindrically, conically or convexly configured sealing skirt which with a receiving section of the neck section which corresponds to the sealing skirt forms a fluid-tight connection, wherein the joining region of the pour-out attachment and of the neck section of the plastic receptacle is different from the fluid-tight connection.

30. A plastic receptacle according to claim 29, wherein the joining region of the pour-out attachment is formed by at least one continuation which extends axially, engages over the neck section on its outer side and is unreleasably connected to the outer side.

31. A plastic receptacle according to claim 25, configured as a preform or a blow moulded plastic container.

32. A plastic receptacle according to claim 25, wherein the pour-out attachment comprises:
an integrally formed closure part.
